(19) United States
(12) Patent Application Publication
(10) Pub. No.: US 2015/0382335 A1
(43) Pub. Date: Dec. 31, 2015

(54) TERMINAL APPARATUS, BASE STATION APPARATUS, COMMUNICATION METHOD, AND STORAGE MEDIUM IN COMMUNICATION SYSTEM IN WHICH COMMUNICATION IS PERFORMED BETWEEN TERMINAL APPARATUSES VIA BASE STATION APPARATUS

(71) Applicant: JVC KENWOOD Corporation, Yokohama-shi (JP)

(72) Inventor: Junichi MIKURIYA, Yokohama-shi (JP)

(21) Appl. No.: 14/704,693

(22) Filed: May 5, 2015

(30) Foreign Application Priority Data
Jun. 30, 2014 (JP) 2014-134046

(51) Int. Cl. H04W 72/04; H04L 5/00

(52) U.S. Cl. CPC H04W 72/0406; H04L 5/0048; H04W 88/02

(57) ABSTRACT

A transmission unit transmits, to a base station apparatus, a first signal including prerequisite information for performing communication. The transmission unit also includes an inquiry request regarding the status of another terminal apparatus in the first signal. A receiving unit receives, from a base station apparatus, a second signal including a response to the information included in the first signal transmitted from the transmission unit. The receiving unit also receives a response to the inquiry request included in the first signal transmitted from the transmission unit.

### CROSS-REFERENCE TO RELATED APPLICATION

This application is based upon and claims the benefit of priority from the prior Japanese Patent Application No. 2014-134046, filed on Jun. 30, 2014, the entire contents of which are incorporated herein by reference.

### BACKGROUND

1. Field of the Invention

The present invention relates to a communication technology and, more particularly, to a terminal apparatus, a base station apparatus, a communication method, and a storage medium in a communication system in which communication is performed between terminal apparatuses via the base station apparatus.

2. Description of the Related Art

In a mobile communication system, a plurality of mobile stations register their existing locations with base stations placed in various places. Management of location registration information by the base stations allows an area in which a mobile station exists to be obtained. Thus, a calling area for a phone call is specified. When a phone call from a mobile station occurs, a base station allocates a communication channel to the mobile station, and a phone call between mobile stations via the base station is made. In that case, when an outgoing call to a mobile station of a call-receiving side is made from a mobile station of a call-originating side, a base station apparatus reads out subscriber information for the mobile station of the call-receiving side from a management system. If a power-off status is registered as status information of a mobile station of the call-receiving side, the base station notifies the mobile station of the call-originating side of the information and does not call the mobile station of the call-receiving side (e.g., Patent document No. 1).

[Patent document No. 1] Japanese Patent Application Publication No. H11-355850

The status of a mobile station is managed by an apparatus of a base station side (home location register). Thus, a mobile station of a call-originating side does not have information regarding the status of a mobile station of a call-receiving side. Therefore, when a mobile station of a call-originating side makes an outgoing call to a mobile station of a call-receiving side, communication access occurs between the mobile station of the call-originating side and a base station even when the mobile station of the call-receiving side is in a power-off status. This transmission is useless, and efficient transmission is desired.

### SUMMARY

In this background, a purpose of the present invention is to provide a technology for efficiently performing transmission of a signal.

A terminal apparatus according to one embodiment of the present invention includes: a transmission unit that transmits, to a base station apparatus, a first signal including prerequisite information for performing communication; and a receiving unit that receives, from a base station apparatus, a second signal including a response to the information included in the first signal transmitted from the transmission unit. The transmission unit also includes an inquiry request regarding the status of another terminal apparatus in the first signal.

Another embodiment of the present invention relates to a base station apparatus. This apparatus includes: a receiving unit that receives, from a first terminal apparatus, a first signal including prerequisite information for performing communication; and a transmission unit that transmits, to the first terminal apparatus, a second signal including a response to the information included in the first signal received by the receiving unit. The first signal received by the receiving unit also includes an inquiry request regarding the status of a second terminal apparatus.

Still another embodiment of the present invention relates to a communication method. This method includes: transmitting, to a base station apparatus, a first signal including prerequisite information for performing communication; and receiving, from a base station apparatus, a second signal including a response to the information included in the first signal that has been transmitted. In the transmission of the first signal, an inquiry request regarding the status of another terminal apparatus is also included in the first signal.

Still another embodiment of the present invention also relates to a communication method. This method includes: receiving, from a first terminal apparatus, a first signal including prerequisite information for performing communication; and transmitting, to a first terminal apparatus, a second signal including a response to the information included in the first signal that has been received. The first signal received in the receiving of the first signal also includes an inquiry request regarding the status of a second terminal apparatus.

Optional combinations of the aforementioned constituting elements and implementations of the invention in the form of methods, apparatuses, systems, recording mediums, and computer programs may also be practiced as additional modes of the present invention.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1 is a diagram illustrating the configuration of a business-use wireless system according to an exemplary embodiment of the present invention;

FIG. 2 is a sequence diagram illustrating a communication procedure by the business-use wireless system shown in FIG. 1;

FIG. 3 is a diagram illustrating the configuration of a terminal apparatus shown in FIG. 1;

FIG. 4 is a diagram illustrating a data structure of a database stored in a memory unit shown in FIG. 3;

FIG. 5 is a diagram illustrating a screen displayed on a display unit shown in FIG. 3;

FIG. 6 is a diagram illustrating another screen displayed on the display unit shown in FIG. 3;

FIG. 7 is a diagram illustrating the configuration of a base station apparatus shown in FIG. 1;

FIG. 8 is a diagram illustrating the configuration of a management apparatus shown in FIG. 1;

FIG. 9 is a diagram illustrating a data structure of a database stored in a memory unit shown in FIG. 8;

FIG. 10 is a sequence diagram illustrating a registration procedure by the business-use wireless system shown in FIG. 1;

FIG. 11 is a sequence diagram illustrating another registration procedure by the business-use wireless system shown in FIG. 1;

FIG. 12 is a sequence diagram illustrating a deletion procedure by the business-use wireless system shown in FIG. 1;

FIG. 13 is a flowchart illustrating a calling procedure by a terminal apparatus shown in FIG. 3; and

FIG. 14 is a flowchart illustrating another calling procedure by the terminal apparatus shown in FIG. 3.

### DETAILED DESCRIPTION

The invention will now be described by reference to the preferred embodiments. This does not intend to limit the scope of the present invention, but to exemplify the invention.

A brief description of the present invention will be given first before a specific description thereof. Exemplary embodiments of the present invention relate to a plurality of base station apparatuses connected to a network, a plurality of terminal apparatuses connected to respective base station apparatuses, and a business-use wireless system including a management apparatus connected to the network. In a business-use wireless system, a group is formed by a plurality of terminal apparatuses. A base station apparatus allocates an uplink channel and a downlink channel to the group. In this kind of situation, one of the terminal apparatuses (hereinafter, referred to as “transmission apparatus”) in the group transmits a signal by the uplink channel, and another terminal apparatus (hereinafter, referred to as “receiving apparatus”) in the group receives the signal by the downlink channel. A base station apparatus that is different from the base station apparatus to which the transmission apparatus is connected also allocates a downlink channel to the group. Thus, a receiving apparatus connected to this base station apparatus is also capable of receiving the signal. Further, the same process is performed on another group. However, communication is not performed between different groups.

As described above, a transmission apparatus does not have information regarding the status of a receiving apparatus, for example, the on/off status of power. Therefore, regardless of whether a receiving apparatus subject to communication is powered off or not, a transmission apparatus transmits a call request to a base station apparatus. If the receiving apparatus is in a power-on status, a management apparatus connected to the base station apparatus allocates a channel to a group in which the receiving apparatus is included and allows communication to be performed. On the other hand, if the receiving apparatus is powered off, the management apparatus does not allocate a channel. Transmission of a call request in such a case is useless.

In order to efficiently transmit a signal, a transmission apparatus according to the present exemplary embodiment includes an inquiry request for inquiring the status of a receiving apparatus in a signal in which prerequisite information for performing communication, for example, a location registration request is included and transmits the signal. A base station apparatus registers the location of the transmission apparatus in response to the location registration request. Also, in response to the inquiry request, the management apparatus acquires information regarding the receiving apparatus that is already registered, for example, power on/off information. The base station apparatus includes the information regarding the receiving apparatus in a signal in which a response to the location registration request is included and transmits the signal. As a result, the transmission apparatus acquires the information regarding the receiving apparatus before transmitting a call request. If the information regarding the receiving apparatus indicates power off, the transmission apparatus does not transmit a call request. The inquiry request is transmitted along with the location registration request, and the information regarding the receiving apparatus is transmitted along with the response to the location registration request. Therefore, a new signal is no longer necessary, and signal transmission is performed efficiently.

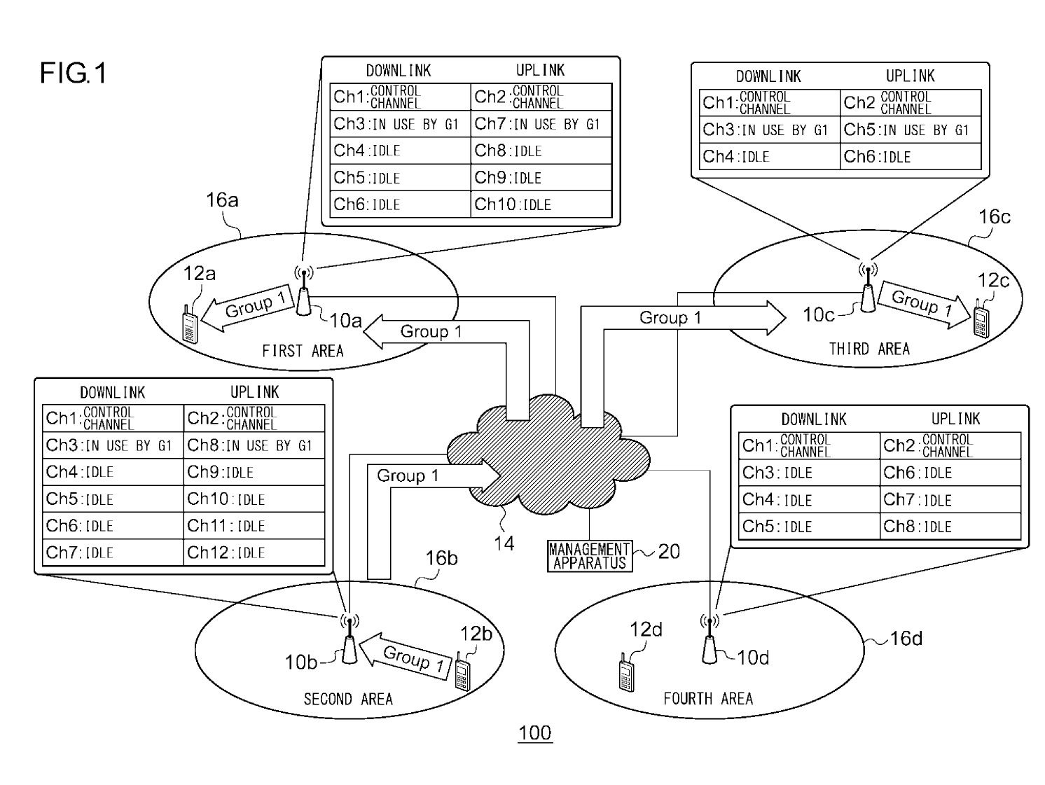

FIG. 1 illustrates the configuration of a business-use wireless system 100 according to an exemplary embodiment of the present invention. The business-use wireless system 100 includes a first base station apparatus 10a, a second base station apparatus 10b, a third base station apparatus 10c, a fourth base station apparatus 10d, which are generically referred to as base station apparatuses 10, a first terminal apparatus 12a, a second terminal apparatus 12b, a third terminal apparatus 12c, a fourth terminal apparatus 12d, which are generically referred to as terminal apparatuses 12, a network 14, and a management apparatus 20. The first base station apparatus 10a forms a first area 16a. The second base station apparatus 10b forms a second area 16b. The third base station apparatus 10c forms a third area 16c. The fourth base station apparatus 10d forms a fourth area 16d. The first area 16a, the second area 16b, the third area 16c, and the fourth area 16d are generically referred to as areas 16. The number of the base station apparatuses 10 and the number of the terminal apparatuses 12 are not limited to “4.”

The first base station apparatus 10a through the fourth base station apparatus 10d are connected to one another via the network 14. A base station apparatus 10 is capable of setting a plurality of channels and allocates each of the channels to a group. Publicly-known techniques need to be used for the channels. As an example, the plurality of channels are multiplexed by time division multiple access (TDMA)/frequency division duplex (FDD). For example, the first base station apparatus 10a sets Ch1 and Ch3 through Ch6 to be downlink channels and sets Ch2 and Ch7 through Ch10 to be uplink channels. Ch1 is used for a downlink control channel, and Ch2 is used for an uplink control channel. Also, Ch3 and Ch7 are allocated to the same group as one combination. The same applies to Ch4 through Ch6 and Ch8 through Ch10. The other base station apparatuses 10 also set channels in the same way. The number of channel that can be set may be different for each base station apparatus 10. Further, Ch1 and Ch2 are assumed to be used for a downlink control channel and an uplink control channel, respectively, in a common manner for all the base station apparatuses 10.

A terminal apparatus 12 is a wireless terminal capable of communicating with another terminal apparatus 12 via a base station apparatus 10. It is assumed that a phone call is performed as communication here. Alternatively, data communication may be performed. When a terminal apparatus 12 enters an area 16, the terminal apparatus 12 requests a base station apparatus 10 that forms the area 16 to perform location registration. The registration of a group to be used is also requested at this time. These requests are included in an uplink control channel of Ch2 and transmitted. The uplink control channel is transmitted by random access. The base station apparatus 10 registers the terminal apparatuses 12 in units of groups according to the requests.

If an outgoing call occurs in one terminal apparatus 12, the terminal apparatus 12 transmits, in Ch2, an uplink control channel in which a call request is included. Having received the uplink control channel, the base station apparatus 10 treats the terminal apparatus 12 as the previously-described transmission apparatus and allocates a channel to a group in which the transmission apparatus is included. The term “channel” used in this case is a general term for a downlink channel and an uplink channel. The base station apparatus 10 requests, via the network 14, another base station apparatus 10 to allocate a channel to this group. In response to the request, the other base station apparatus 10 checks whether the group is registered. If the group is registered, the other base station apparatus 10 allocates a channel to the group.

The base station apparatus 10 and the other base station apparatus 10 transmit a downlink control channel in which the information regarding an allocated channel is included to terminal apparatuses 12. A receiving apparatus, which is a remaining terminal apparatus 12 included in the group, and the transmission apparatus recognize the allocated channel by receiving the downlink control channel. The transmission apparatus transmits a signal by an allocated uplink channel to the base station apparatus 10. The signal includes a digitalized audio signal. If the receiving apparatus is included in the group in which the transmission apparatus is included, the base station apparatus 10 transmits the signal to the receiving apparatus by an allocated downlink channel. The base station apparatus 10 transmits the received signal to the other base station apparatus 10. The other base station apparatus 10 transmits the signal to the receiving apparatus by the allocated downlink channel. The receiving apparatus reproduces the audio signal based on the received signal and outputs audio from a speaker.

As described, a plurality of groups in which a plurality of terminal apparatuses 12 are included are formed. Each one of the plurality of base station apparatuses 10 allocates channels in units of groups. As a result, communication is performed from one terminal apparatus 12 included in a group to which a channel is allocated to a remaining terminal apparatus 12 included in the group.

A transmission apparatus and a receiving apparatus may be switched with each other among a plurality of terminal apparatuses 12 included in a group. When a signal to be transmitted is generated in a terminal apparatus 12 that has operated as a receiving apparatus, the terminal apparatus 12 is switched to a transmission apparatus by transmitting an uplink control channel in which a call request is included, as described previously. Also, a terminal apparatus 12 that has operated as a transmission apparatus switches to a receiving apparatus once the transmission of a signal is ended. When one phone call occurs, such a group phone call uses one channel of each base station apparatus 10. Therefore, when a terminal apparatus 12 included in the same group is registered in base station apparatuses 10 in a large area, channels that are as many as the number of the base station apparatuses 10 are used for one phone call. The above process is performed for each group.

FIG. 1 shows a situation where a phone call of Group 1 is performed. A second terminal apparatus 12b corresponds to a transmission apparatus. The second terminal apparatus 12b transmits a signal using Ch8 of a second base station apparatus 10b. Group 1 is registered in a first base station apparatus 10a and a third base station apparatus 10c. Therefore, a first terminal apparatus 12a receives the signal using Ch3 of the first base station apparatus 10a, and a third terminal apparatus 12c receives the signal using Ch3 of the third base station apparatus 10c. On the other hand, since Group 1 is not registered in a fourth base station apparatus 10d, the signal from the second terminal apparatus 12b is not output to the fourth base station apparatus 10d.

For example, when Group 1 is registered only in the second base station apparatus 10b, a transmission apparatus transmits a signal through Ch8 of the second base station apparatus 10b, and a receiving apparatus receives the signal through Ch3 of the second base station apparatus 10b, upon the occurrence of a phone call of Group 1. Therefore, one set of channels of only one base station apparatus 10 is used. Also, when Group 1 is registered in two base station apparatuses 10, a set of channels is used in each of the two base station apparatuses 10 upon the occurrence of a phone call of Group 1. Therefore, two sets of channels are used. This corresponds to channel consumption in an amount that is the same as that for a one-to-one phone call such as in a mobile phone system. Further, when Group 1 is registered in three or more base station apparatuses 10, three or more sets of channels are consumed. When all the channels of the third base station apparatus 10c are being used by another group, a phone call for Group 1 is not performed in the third base station apparatus 10c. This corresponds to a missed call or a busy state.

Prior to a communication process, when the second terminal apparatus 12b acquires a control channel by performing a power-on/off operation, the second terminal apparatus 12b transmits an uplink control channel including a location registration request to a base station apparatus 10. In addition to the location registration request, an inquiry request regarding another terminal apparatus 12 whose status is desired to be managed is included in this uplink control channel. Information regarding the other terminal apparatus 12 requested by the inquiry request includes information regarding each terminal apparatus 12 that is set by a system manager or information regarding a group to which the terminal apparatus 12 belongs as a base station apparatus 10. In addition to registering information regarding the second terminal apparatus 12b, the second base station apparatus 10b also registers the status of the second terminal apparatus 12b in the management apparatus 20 connected via the network 14. Further, the second base station apparatus 10b outputs an inquiry request to the management apparatus 20.

The management apparatus 20 manages the respective statuses of a plurality of terminal apparatuses 12 and adds the status of the second terminal apparatus 12b. Also, the management apparatus 20 outputs the status of a terminal apparatus 12 that is required according to the inquiry request to the second base station apparatus 10b. The second base station apparatus 10b includes information regarding the status of the other terminal apparatus 12 received from the management apparatus 20 in a downlink control channel as well as a response to the location registration request and transmits the downlink control channel. The second terminal apparatus 12b stores the status of the other terminal apparatus 12 inside thereof based on the downlink control channel that is received. Further, each terminal apparatus 12 is informed of the update of the status of the second terminal apparatus 12b by a base station apparatus 10. Another terminal apparatus 12 whose location have already been registered, for example, the first terminal apparatus 12a receives the information as informed and stored the status of the second terminal apparatus 12b if necessary.

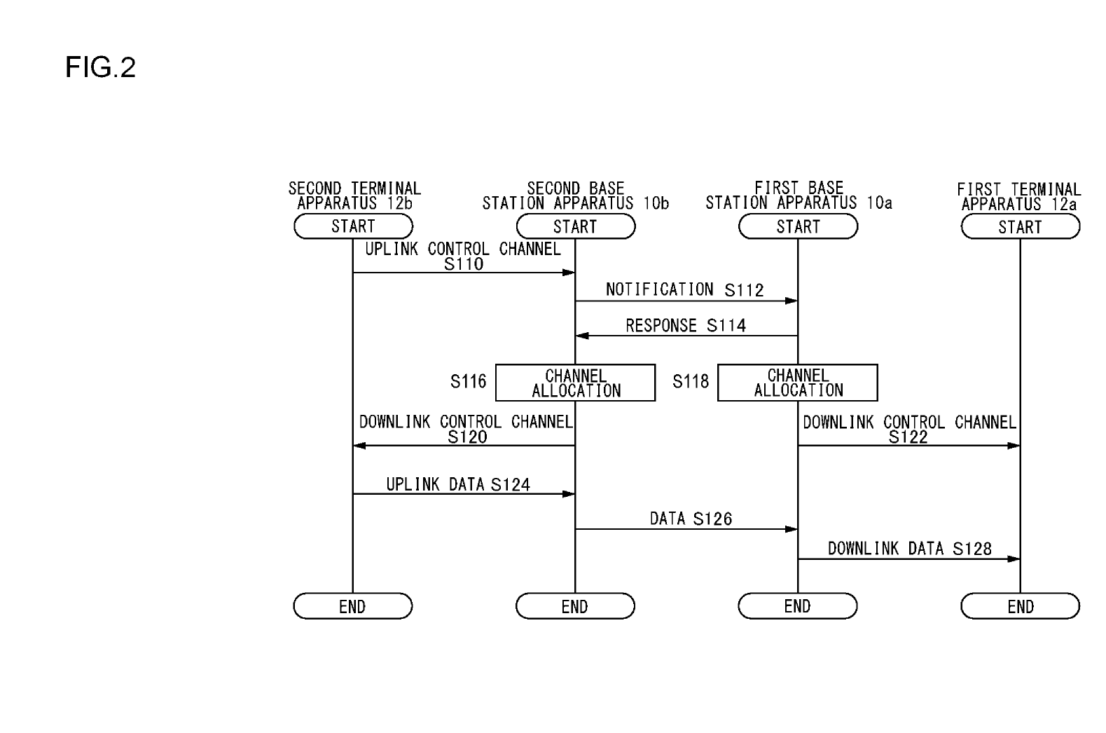

FIG. 2 is a sequence diagram illustrating a communication procedure by a business-use wireless system 100. The second terminal apparatus 12b transmits a call request through an uplink control channel (S110). The second base station apparatus 10b notifies the first base station apparatus 10a of the call request (S112). The first base station apparatus 10a notifies the second base station apparatus 10b of a response to the call request (S114). The second base station apparatus 10b and the first base station apparatus 10a allocate a channel to Group 1 (S116, S118). The second base station apparatus 10b and the first base station apparatus 10a transmit an allocation result through a downlink control channel (S120, S122). The second terminal apparatus 12b transmits uplink data to the second base station apparatus 10b (S124). The second base station apparatus 10b transmits data to the first base station apparatus 10a (S126). The first base station apparatus 10a transmits downlink data to the first terminal apparatus 12a (S128).

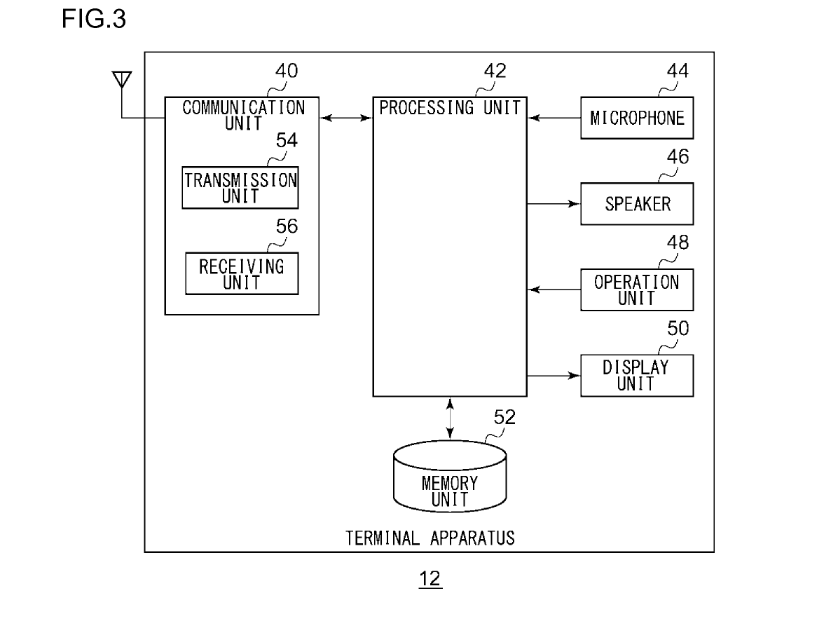

FIG. 3 illustrates the configuration of a terminal apparatus 12. A terminal apparatus 12 includes a communication unit 40, a processing unit 42, a microphone 44, a speaker 46, an operation unit 48, a display unit 50, and a memory unit 52. The communication unit 40 includes a transmission unit 54 and a receiving unit 56.

At the time of a phone call, the microphone 44 receives audio from a user and converts the audio into an audio signal. The microphone 44 outputs the audio signal to the processing unit 42. At the time of a phone call, the speaker 46 receives the audio signal from the processing unit 42 and outputs the audio signal as audio. The speaker 46 may output an alarm sound or the like. The operation unit 48 is formed with a button, a touch panel, or the like and receives input from a user. The operation unit 48 outputs the received input to the processing unit 42. The display unit 50 receives an image and a message from the processing unit 42 and displays those. If a screen is a touch panel, the display unit 50 is formed integrally with the operation unit 48. It is also possible to employ a configuration where a display apparatus (not shown) is connected to the terminal apparatus 12 without including the display unit 50 in the terminal apparatus 12 so that information is displayed on the external display apparatus.

When the terminal apparatus 12 is powered on or when the terminal apparatus 12 enters a new area 16, the processing unit 42 generates a location registration request. Also, the processing unit 42 generates an inquiry request with respect to another terminal apparatus 12. An inquiry request is a request for inquiring the status of another terminal apparatus 12, for example, whether the power of the other terminal apparatus 12 is on or off. The other terminal apparatus 12 may be a terminal apparatus 12 that is selected by a user via the operation unit 48 or another terminal apparatus 12 that is included in the same group as that of the present terminal apparatus 12. The processing unit 42 transmits the location registration request and the inquiry request together to the transmission unit 54. The transmission unit 54 includes the location registration request and the inquiry request in an uplink control channel and transmits the uplink control channel to the base station apparatus 10.

After the transmission of the uplink control channel, the receiving unit 56 receives a downlink control channel from the base station apparatus 10. This downlink control channel includes a response to the location registration request and a notification regarding the status of another terminal apparatus 12. A response that corresponds to a location registration request is information that shows whether or not location registration has been made and, for example, shows that the location registration has been made. A notification regarding the status of another terminal apparatus 12 is a response to an inquiry request and shows whether the power of the other terminal apparatus 12 is on or off. The receiving unit 56 outputs the response to the location registration request and the notification regarding the status of the other terminal apparatus 12 to the processing unit 42.

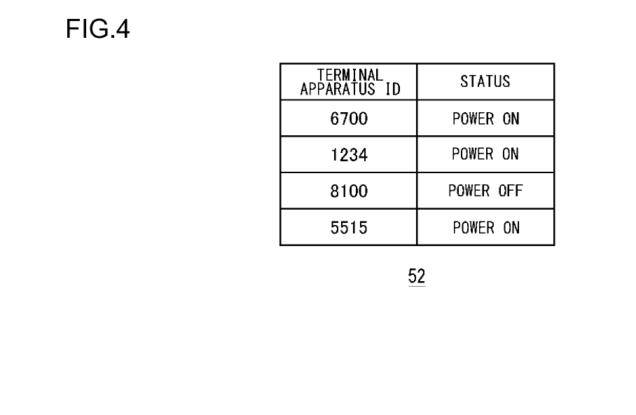

The processing unit 42 learns that the other terminal apparatus 12 is in a communicable status based on the response to the location registration request. The processing unit 42 stores the notification regarding the status of the other terminal apparatus 12 in the memory unit 52. FIG. 4 shows the data structure of a database stored in the memory unit 52. The database shows respective terminal apparatus ID's for identifying terminal apparatuses 12 and shows whether the power of the terminal apparatuses 12 is on or off. FIG. 3 is referred back.

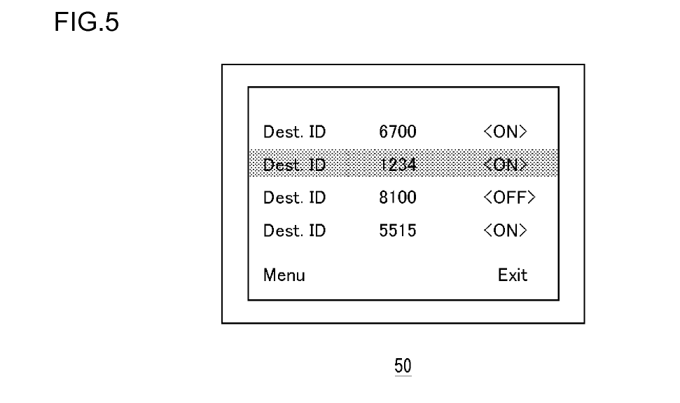

Before making a call after such processes, the processing unit 42 generates a list screen for contact information based on information stored in the memory unit 52 and allows the generated list screen to be displayed on the display unit 50. FIG. 5 illustrates a screen displayed on the display unit 50. The terminal apparatus ID's shown in FIG. 4 are shown as “Dest. ID's”. When the power is on, <ON> is shown, and when the power is off, <OFF> is shown. These correspond to responses to an inquiry request. In this manner, the display unit 50 displays another terminal apparatus 12 that is subject to communication. FIG. 3 is referred back.

The user selects a terminal apparatus 12 subject to communication by operating the operation unit 48 while checking the list screen displayed on the display unit 50. A terminal apparatus 12 indicated as <OFF> is set to be non-selectable at that time. As a result, the processing unit 42 does not generate a call request for a terminal apparatus 12 whose power is off. On the other hand, when a terminal apparatus 12 whose power is on is selected, the processing unit 42 generates a call request, and the transmission unit 54 transmits an uplink control channel that includes the call request. A communication process that follows this is as described previously. Therefore, an explanation thereof is omitted.

Different from a case in FIG. 5, <ON> for a case where the power is on and <OFF> for a case where the power is off do not need to be displayed in the list screen displayed on the display unit 50. The user selects a terminal apparatus 12 subject to communication by operating the operation unit 48 while checking the list screen displayed on the display unit 50. When a terminal apparatus 12 whose power is off is selected, the processing unit 42 generates a screen for showing that a call cannot be made and allows the generated screen to be displayed on the display unit 50. The display unit 50 displays the generated screen.

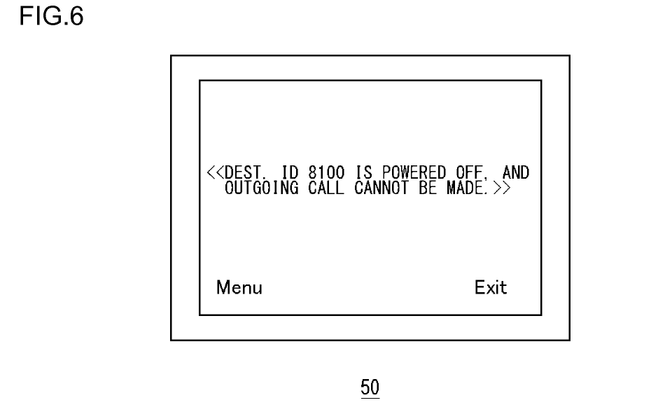

FIG. 6 illustrates another screen that is displayed on the display unit 50. As shown in the figure, “Dest. ID 8100 is powered off, and outgoing call cannot be made” is displayed. In other words, when another terminal apparatus 12 that is indicated as non-communicable in a notification regarding the status is selected as a communication target, the display unit 50 displays that the other terminal apparatus 12 is non-communicable. FIG. 3 is referred back. When a terminal apparatus 12 whose power is on is selected, the processing unit 42 generates a call request, and the transmission unit 54 transmits an uplink control channel that includes the call request, as described previously.

The power of a terminal apparatus 12 is turned off by operating the operation unit 48. When a terminal apparatus 12 transitions from a power-on status to a power-off status, the processing unit 42 generates a registration deletion request. The transmission unit 54 transmits an uplink control channel in which the registration deletion request is included to the base station apparatus 10. The base station apparatus 10 that has received the uplink control channel transmits a downlink control channel. This downlink control channel includes a response to the registration deletion request.

The configuration is implemented in hardware by any CPU of a computer, memory or other LSI's, and in software by a program or the like loaded into the memory. FIG. 3 depicts functional blocks implemented by the cooperation of hardware and software. Thus, a person skilled in the art should appreciate that there are many ways of accomplishing these functional blocks in various forms in accordance with the components of hardware only, software only, or the combination of both.

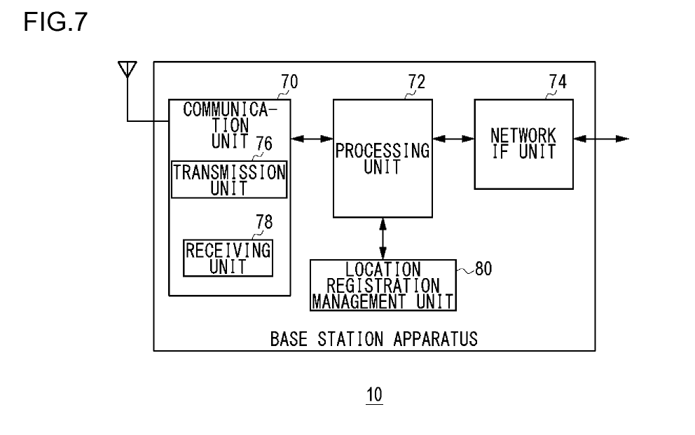

FIG. 7 illustrates the configuration of a base station apparatus 10. The base station apparatus 10 includes a communication unit 70, a processing unit 72, a network IF unit 74, and a location registration management unit 80. The communication unit 70 includes a transmission unit 76 and a receiving unit 78.

The receiving unit 78 receives an uplink control channel from a terminal apparatus 12. The uplink control channel includes a location registration request and an inquiry request. The receiving unit 78 outputs the location registration request and the inquiry request to the processing unit 72. The processing unit 72 outputs the location registration request to the location registration management unit 80, and the location registration management unit 80 stores the location information of the terminal apparatus 12. When the location registration management unit 80 stores the location information, the location registration management unit 80 generates information indicating that the location information has been stored as a response to the location registration request and outputs the information to the processing unit 72.

The processing unit 72 outputs the location registration request and the inquiry request to the network IF unit 74, and the network IF unit 74 transmits the location registration request and the inquiry request to the management apparatus 20 via the network 14. The network IF unit 74 receives a notification regarding the status of another terminal apparatus 12 from the management apparatus 20 as a response to the inquiry request. The network IF unit 74 outputs the notification regarding the status of the other terminal apparatus 12 to the processing unit 72. The processing unit 72 outputs the response to the location registration request and the notification regarding the status of the other terminal apparatus 12 to the transmission unit 76. The transmission unit 76 transmits, to the terminal apparatus 12, a downlink control channel in which the response to the location registration request and the notification regarding the status of the other terminal apparatus 12 are included.

After the transmission of the downlink control channel, the transmission unit 76 informs another terminal apparatus 12 inside the area 16 of an announcement message. The announcement message shows that the power of the terminal apparatus 12 is on. The other terminal apparatus 12 that has received the announcement message updates the database in the memory unit 52 by the announcement message.

The receiving unit 78 receives the uplink control channel in which the registration deletion request is included from the terminal apparatus 12. The processing unit 72 outputs the registration deletion request to the location registration management unit 80, and the location registration management unit 80 deletes the location information of the terminal apparatus 12. When the location registration management unit 80 deletes the location information, the location registration management unit 80 generates information indicating that the location information has been deleted as a response to the registration deletion request and outputs the information to the processing unit 72. The processing unit 72 outputs the registration deletion request to the network IF unit 74, and the network IF unit 74 transmits the registration deletion request to the management apparatus 20 via the network 14. The processing unit 72 outputs a response to the registration deletion request to the transmission unit 76, and the transmission unit 76 transmits a downlink control channel in which the response to the registration deletion request is included to the terminal apparatus 12. Further, after the transmission of the downlink control channel, the transmission unit 76 informs another terminal apparatus 12 inside the area 16 of an announcement message that indicates that the power of the terminal apparatus 12 is off.

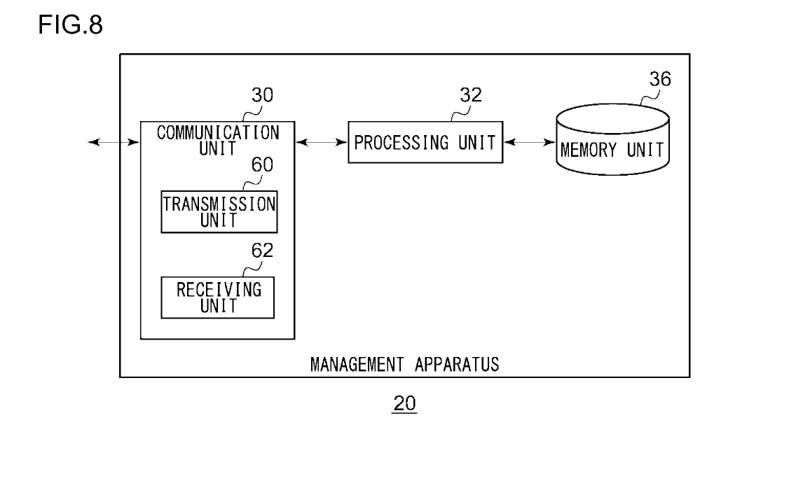

FIG. 8 illustrates the configuration of the management apparatus 20. The management apparatus 20 includes a communication unit 30, a processing unit 32, and a memory unit 36. The communication unit 30 includes a transmission unit 60 and a receiving unit 62.

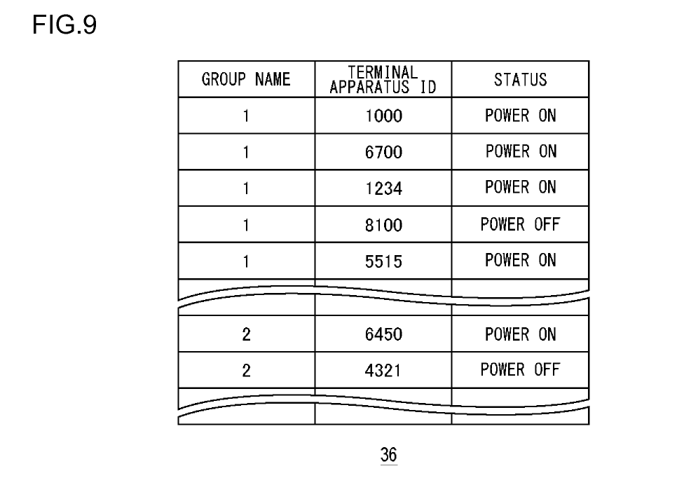

The receiving unit 62 is connected to the network 14 and receives a location registration request and an inquiry request from the terminal apparatus 12 via the base station apparatus 10. The processing unit 32 receives the location registration request from the receiving unit 62 and stores the location registration request in a database. The memory unit 36 stores information regarding each terminal apparatus 12 as a database. FIG. 9 illustrates the data structure of a database stored in the memory unit 36. In an example shown in FIG. 9, “group name,” “terminal apparatus ID,” and “status” are included. The group name (group number) shows identification information for a group in which a terminal apparatus 12 is included, and “terminal apparatus ID” is also referred to as “Unit ID” and, as described previously, is a number for uniquely identifying a terminal apparatus. The “status” shows whether the power of a terminal apparatus 12 is on or off. Storing a location registration request changes the status of a corresponding terminal apparatus 12 from power off to power on. FIG. 8 is referred back.

The processing unit 32 receives an inquiry request from the receiving unit 62. The inquiry request includes one or more terminal apparatus ID's of a terminal apparatus 12 subject to inquiry. Based on the terminal apparatus ID included in the inquiry request, the processing unit 32 searches the database stored in the memory unit 36 and extracts a status that corresponds to the terminal apparatus ID. Based on the combination of the extracted status and the terminal apparatus ID, the processing unit 32 generates a notification regarding the status of another terminal apparatus 12. The transmission unit 60 transmits the notification regarding the status of the other terminal apparatus 12 to the base station apparatus 10 via the network 14.

The receiving unit 62 also receives a registration deletion request from the terminal apparatus 12 via the base station apparatus 10. The processing unit 32 receives the registration deletion request and executes a change in the database based on the registration deletion request. Specifically, the status of a corresponding terminal apparatus 12 is changed from power on to power off.

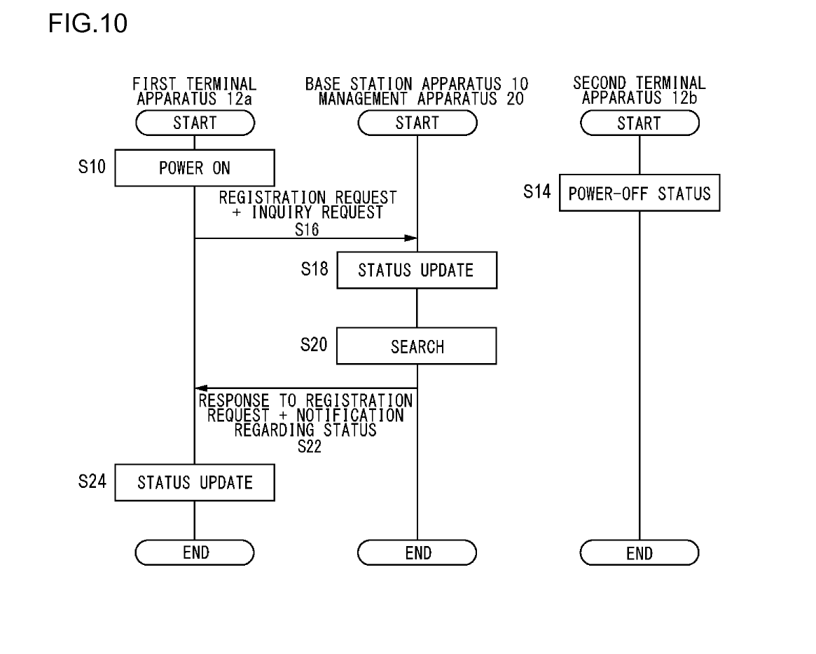

An explanation will be given of the operation of a business-use wireless system 100 having the above-stated structure. The second terminal apparatus 12b and the first terminal apparatus 12a are thus far assumed to be a transmission apparatus and a receiving apparatus, respectively. However, the first terminal apparatus 12a and the second terminal apparatus 12b are now assumed to be a transmission apparatus and a receiving apparatus, respectively. FIG. 10 is a sequence diagram illustrating a registration procedure by the business-use wireless system 100. The power of the first terminal apparatus 12a is turned on (S10). The second terminal apparatus 12b is set to be in a power-off status (S14). The first terminal apparatus 12a transmits a registration request and an inquiry request (S16). In the inquiry request, the status of the second terminal apparatus 12b is inquired. The management apparatus 20 updates the status based on the registration request (S18) and performs a search based on the inquiry request (S20). The base station apparatus 10 transmits a response to the registration request and a notification regarding the status (S22). The first terminal apparatus 12a updates the status based on the notification regarding the status (S24).

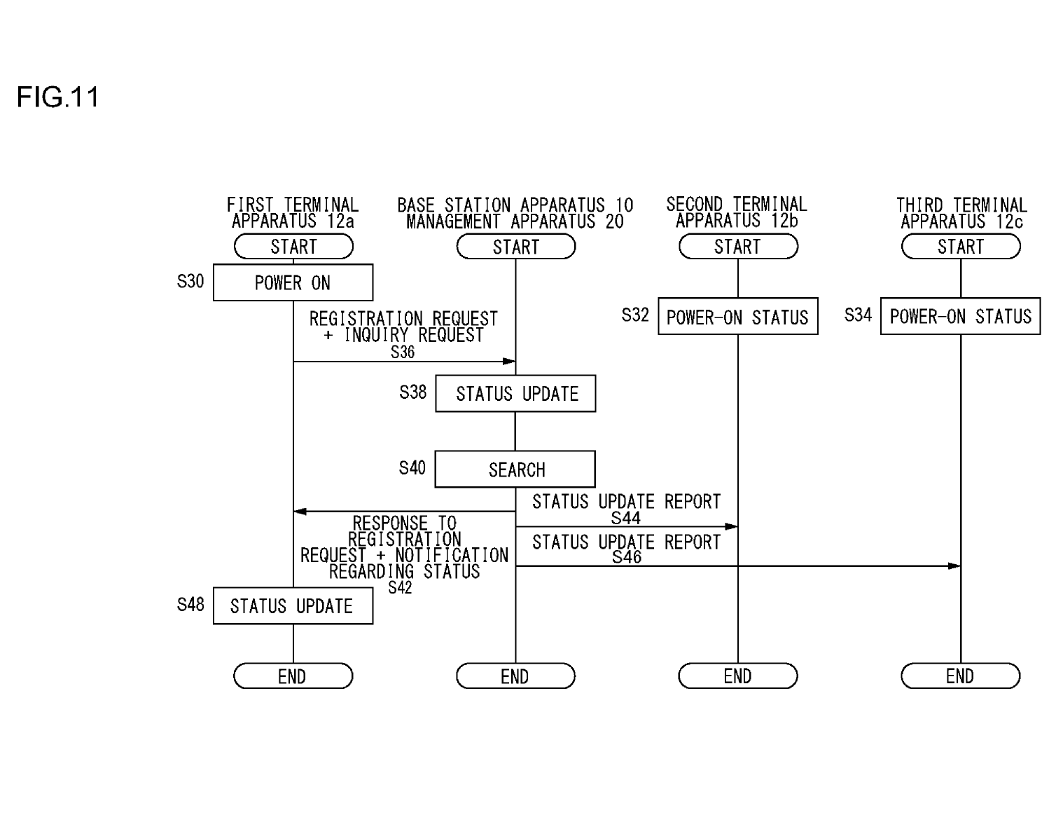

FIG. 11 is a sequence diagram illustrating another registration procedure by the business-use wireless system 100. The power of the first terminal apparatus 12a is turned on (S30). The second terminal apparatus 12b is set to be in a power-on status (S32), and the third terminal apparatus 12c is also set to be in a power-on status (S34). The first terminal apparatus 12a transmits a registration request and an inquiry request (S36). In the inquiry request, the status of the second terminal apparatus 12b and the status of the third terminal apparatus 12c are inquired. The management apparatus 20 updates the status based on the registration request (S38) and performs a search based on the inquiry request (S40). The base station apparatus 10 transmits a response to the registration request and a notification regarding the status (S42). The base station apparatus 10 reports a status update (S44, S46). The first terminal apparatus 12a updates the status based on the notification regarding the status (S48).

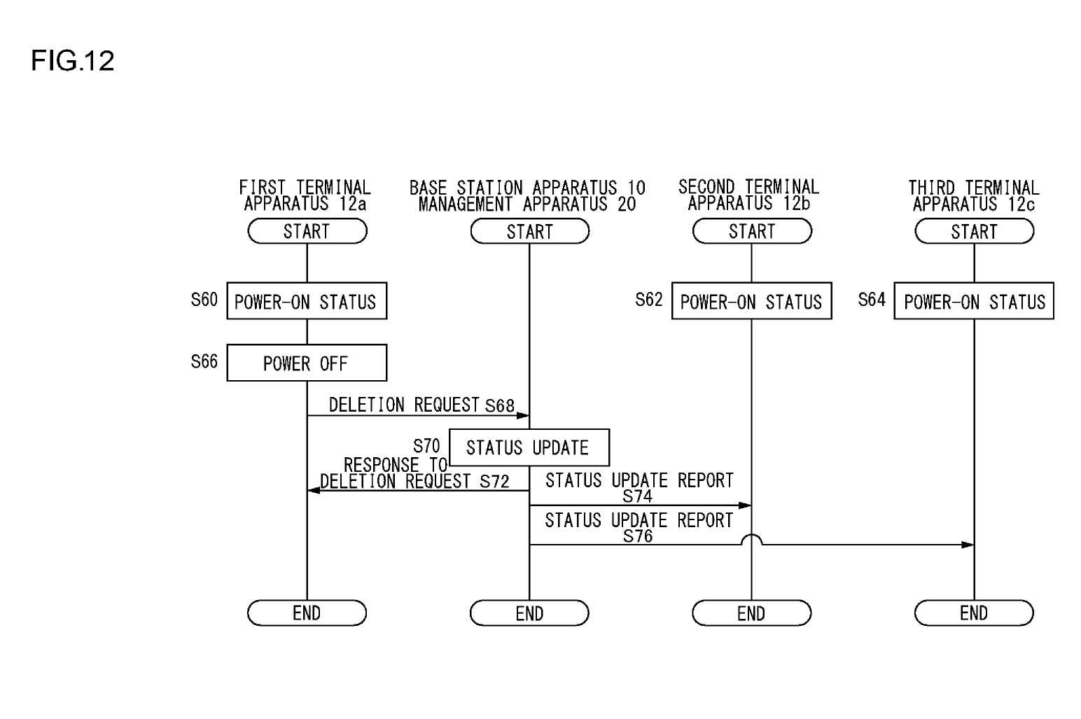

FIG. 12 is a sequence diagram illustrating a deletion procedure by the business-use wireless system 100. The first terminal apparatus 12a is set to be in a power-on status (S60). The second terminal apparatus 12b is set to be in a power-on status (S62), and the third terminal apparatus 12c is also set to be in a power-on status (S64). The first terminal apparatus 12a is powered off (S66). The first terminal apparatus 12a transmits a deletion request (S68). The management apparatus 20 updates the status based on the deletion request (S70). The base station apparatus 10 transmits a response to the deletion request (S72). The base station apparatus 10 reports a status update (S74, S76).

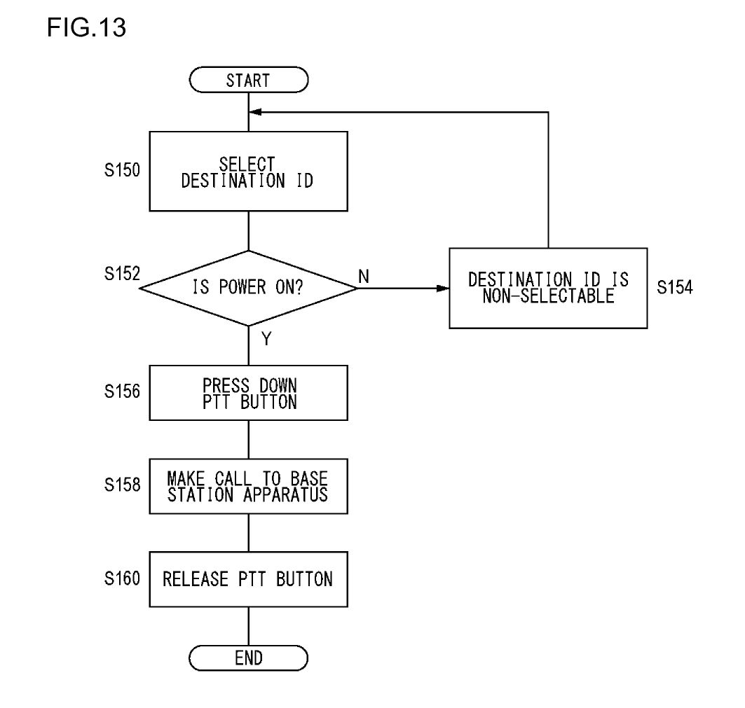

FIG. 13 is a flowchart indicating a calling procedure performed by a terminal apparatus 12. Destination ID is selected via an operation unit 48 (S150). If the power of another terminal apparatus 12 that corresponds to Destination ID is not ON (N in S152), Destination ID cannot be selected (S154), and the flow goes back to step S150. If the power of the other terminal apparatus 12 that corresponds to Destination ID is ON (Y in S152) and a PTT button is pressed down (S156), the processing unit 42 and the transmission unit 54 make a call to the base station apparatus 10 (S158). The PTT button is released (S160).

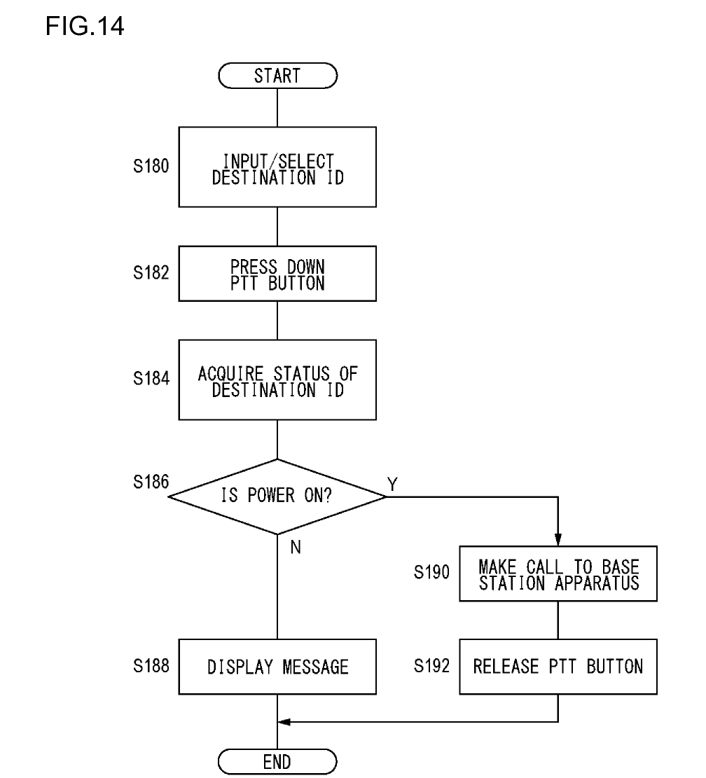

FIG. 14 is a flowchart indicating another calling procedure performed by the terminal apparatus 12. Destination ID is input/selected via the operation unit 48 (S180). If the PTT button is pressed down (S182), the processing unit 42 acquires the status of Destination ID (S184). If the power of another terminal apparatus 12 that corresponds to Destination ID is not ON (N in S186), the display unit 50 displays a message indicating that communication cannot be performed (S188). If the power of the other terminal apparatus 12 that corresponds to Destination ID is ON (Y in S186), the processing unit 42 and the transmission unit 54 make a call to the base station apparatus 10 (S190). The PTT button is released (S192).

According to the present exemplary embodiment, since an inquiry request is transmitted along with a location registration request, the transmission of a signal can be efficiently performed. Further, since a notification regarding a status is received along with the location registration request, the transmission efficiency can be improved. Since a power-off status of another terminal apparatus is obtained before a call is made, unnecessary transmission of a call request can be prevented. Further, since the other terminal apparatus displays whether or not the power is off, a call to the other terminal apparatus whose power is off can be prevented. Even when the other terminal apparatus whose power is off is selected, unnecessary transmission can be prevented since a call request to the other terminal apparatus is not transmitted. When the other terminal apparatus whose power is off is selected, information indicating that communication cannot be performed is displayed. Thus, a user can be notified that a call request is not transmitted. Also, since information indicating that the status of one terminal apparatus has been updated to be a power-on status is reported to another terminal apparatus, the latest status can be shared.

Described above is an explanation based on the exemplary embodiments of the present invention. These exemplary embodiments are intended to be illustrative only, and it will be obvious to those skilled in the art that various modifications to constituting elements and processes could be developed and that such modifications are also within the scope of the present invention.

In the exemplary embodiment of the present invention, the management apparatus 20 is connected to the network 14. However, the embodiment is not limited to this example. For example, the management apparatus 20 may be embedded in any one of base station apparatuses 10. According to the present variation, the degree of freedom in the structure can be improved.

In the exemplary embodiment of the present invention, the base station apparatuses 10, the terminal apparatuses 12, and the management apparatus 20 are included in the business-use wireless system 100. However, the embodiment is not limited to this example. For example, the base station apparatuses 10, the terminal apparatuses 12, and the management apparatus 20 may be included in a wireless communication system such as a mobile phone system. According to the present variation, the degree of freedom in the structure can be improved.

In the exemplary embodiment of the present invention, prerequisite information for performing communication is assumed to be a location registration request. However, the embodiment is not limited to this example. For example, the prerequisite information for performing communication may be information other than a location registration request. The information other than a location registration request is a request for changing a group, channel quality information (CQI), or the like. In other words, the information may be any information that is to be transmitted before communication is performed. According to the present variation, the degree of freedom in the structure can be improved.

In the exemplary embodiment of the present invention, a notification regarding a status is transmitted along with a location registration request. However, the embodiment is not limited to this example. For example, a location registration request and a notification regarding a status may be transmitted separately. According to the present variation, the degree of freedom in the structure can be improved.

What is claimed is:

1. A terminal apparatus comprising:
a transmission unit that transmits, to a base station apparatus, a first signal including prerequisite information for performing communication; and
a receiving unit that receives, from a base station apparatus, a second signal including a response to the information included in the first signal transmitted from the transmission unit,
wherein the transmission unit also includes an inquiry request regarding the status of another terminal apparatus in the first signal.

2. The terminal apparatus according to claim 1,
wherein the second signal received by the receiving unit also includes a response to the inquiry request included in the first signal transmitted from the transmission unit.

3. The terminal apparatus according to claim 1, further comprising:
a display unit that displays another terminal apparatus subject to communication,
wherein the display unit also displays a response to the inquiry request included in the first signal transmitted from the transmission unit.

4. The terminal apparatus according to claim 2, further comprising:
a display unit that displays another terminal apparatus subject to communication,
wherein the display unit also displays a response to the inquiry request included in the first signal transmitted from the transmission unit.

5. The terminal apparatus according to claim 1, further comprising:
a display unit that displays that the other terminal apparatus is non-communicable if the other terminal apparatus is selected as a communication target when the response to the inquiry request included in the first signal transmitted from the transmission unit shows that the other terminal apparatus is non-communicable.

6. The terminal apparatus according to claim 2, further comprising:
a display unit that displays that the other terminal apparatus is non-communicable if the other terminal apparatus is selected as a communication target when the response to the inquiry request included in the first signal transmitted from the transmission unit shows that the other terminal apparatus is non-communicable.

7. A base station apparatus comprising:
a receiving unit that receives, from a first terminal apparatus, a first signal including prerequisite information for performing communication; and
a transmission unit that transmits, to the first terminal apparatus, a second signal including a response to the information included in the first signal received by the receiving unit,
wherein the first signal received by the receiving unit also includes an inquiry request regarding the status of a second terminal apparatus.

8. The base station apparatus according to claim 7,
wherein the transmission unit also includes, in the second signal, a response to the inquiry request included in the first signal received by the receiving unit.

9. A communication method comprising:
transmitting, to a base station apparatus, a first signal including prerequisite information for performing communication; and
receiving, from a base station apparatus, a second signal including a response to the information included in the first signal that has been transmitted,
wherein, in the transmission of the first signal, an inquiry request regarding the status of another terminal apparatus is also included in the first signal.

10. A communication method comprising:
receiving, from a first terminal apparatus, a first signal including prerequisite information for performing communication; and
transmitting, to a first terminal apparatus, a second signal including a response to the information included in the first signal that has been received,
wherein the first signal received in the receiving of the first signal also includes an inquiry request regarding the status of a second terminal apparatus.

11. A non-transitory computer-readable storage medium having embodied thereon a program product comprising:
transmitting, to a base station apparatus, a first signal including prerequisite information for performing communication; and
receiving, from a base station apparatus, a second signal including a response to the information included in the first signal that has been transmitted,
wherein, in the transmission of the first signal, an inquiry request regarding the status of another terminal apparatus is also included in the first signal.

12. A non-transitory computer-readable storage medium having embodied thereon a program product comprising:
receiving, from a first terminal apparatus, a first signal including prerequisite information for performing communication; and
transmitting, to a first terminal apparatus, a second signal including a response to the information included in the first signal that has been received,
wherein the first signal received in the receiving of the first signal also includes an inquiry request regarding the status of a second terminal apparatus.
